(19) United States
(12) Patent Application Publication
(10) Pub. No.: US 2016/0354813 A1
(43) Pub. Date: Dec. 8, 2016

(54) Apparatus and Method for Cleaning Devices Internally Through Their Ports

(71) Applicants: Peter T. Jachim, Merillville, IN (US); Charles R. Pruha, JR., Munster, IN (US)

(72) Inventors: Peter T. Jachim, Merillville, IN (US); Charles R. Pruha, JR., Munster, IN (US)

(73) Assignee: Arrow Pin & Products Inc., South Chicago Heights, IL (US)

(21) Appl. No.: 14/731,089

(22) Filed: Jun. 4, 2015

(51) Int. Cl. B08B 9/00; B08B 13/00

(52) U.S. Cl. CPC B08B 9/00; B08B 13/00

(57) ABSTRACT

An apparatus for cleaning internally a device having internal pathways and five sets of pathway ports, each of which is positioned one of five sides of the device is provided. The apparatus includes an upper housing that includes a cleaning chamber and a getaway openably closable by a door, a cleaning assembly, which is installed within the cleaning chamber, includes five sets of nozzles, each of which is positioned on one of five sides of the cleaning assembly, and a couple of guide rails on which the device is placed during a cleaning process. The apparatus further includes a cleaning control unit configured to control the cleaning process of the device once placed within the cleaning assembly, wherein the cleaning control unit is coupled to a pressure pump that is coupled to the five sets of nozzles to provide cleaning media at a predetermined pressure to the five sets of pathway ports during the cleaning process, and a push-button control unit for starting, stopping, and providing a status of the cleaning process.

### BACKGROUND

Unless otherwise indicated herein, the materials described in this section are not prior art to the claims in this application and are not admitted to be prior art by inclusion in this section.

Current processes for internally cleaning devices having internal passageways involve the use of an autoclave process and a high pressure wash. The high pressure wash uses a manifold with probes introduced manually by an individual into a corresponding number of root openings of the internal passageways being cleaned. High pressure water is then pumped through the probes of the manifold.

As known, there are two air valve bodies on each train car, one air valve body is for service air and the other air valve body is an emergency air valve. Being configured for a dual purpose, the emergency valve operates during a loss of air (emergency) and maintains service when the service valve fails.

Conventionally, used air valve bodies are rebuilt. During the rebuilding process, the air valve body is disassembled, pressure cleaned with fluids, and an individual manually rotates the air valve body repeatedly to blow dry all ports with an air gun. Accordingly, conventionally an individual is needed for internal cleaning of devices and blow drying their ports.

Therefore, a definite need exists for an apparatus to remove debris and liquids from castings through their ports without requiring a manual participation of an individual.

### SUMMARY

According to an exemplary embodiment of the present disclosure, an apparatus is provided for cleaning devices internally through their ports.

According to one aspect, an apparatus for cleaning internally a device having internal pathways and five sets of pathway ports, each of which is positioned one of five sides of the device is provided. The apparatus includes an upper housing that includes a cleaning chamber and a getaway openably closable by a door, a cleaning assembly, which is installed within the cleaning chamber, includes five sets of nozzles, each of which is positioned on one of five sides of the cleaning assembly, and a couple of guide rails on which the device is placed during a cleaning process. The apparatus further includes a cleaning control unit configured to control the cleaning process of the device once placed within the cleaning assembly, wherein the cleaning control unit is coupled to a pressure pump that is coupled to the five sets of nozzles to provide cleaning media at a predetermined pressure to the five sets of pathway ports during the cleaning process, and a push-button control unit for starting, stopping, and providing a status of the cleaning process.

According to another aspect, the cleaning assembly further includes internally a movable member that extends from a back end along a longitudinal axis of the guide rails so that a front end of the movable member can be positioned by an operator at a predetermined number of positions from the back side of the cleaning assembly, each of which corresponds to a specific positive cleaning position of the device.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the disclosure by way of example only and not by way of limitation.

In yet another aspect, the push-button control unit includes a start button, a stop button, and a cleaning status light indicator, which is configured to inform the operator about a current cleaning status of the device.

In yet another aspect, the cleaning status light indicator is further configured to inform the operator about faults of the cleaning process using a flashing frequency.

### BRIEF DESCRIPTION OF DRAWINGS

To understand the present disclosure, it will now be described by way of example, with reference to the accompanying drawings in which:

FIG. 1 illustrates a front side elevation view of an exemplary embodiment of an apparatus for cleaning devices through their ports;

FIG. 2 illustrates a perspective elevation view of the exemplary embodiment of the apparatus for cleaning devices through their ports of FIG. 1;

FIG. 3 illustrates a perspective view of an exemplary embodiment of a cleaning assembly that includes nozzles for cleaning devices through their ports;

FIG. 4 illustrates an exploded view of an upper housing of the exemplary embodiment of the apparatus of FIG. 1 and a perspective view of a device to be placed inside the cleaning assembly for cleaning the internal pathways of the device;

FIG. 5 illustrates a front side elevation view of the exemplary embodiment of the apparatus of FIG.1 with the device of FIG. 4 to be cleaned positioned inside the upper housing;

FIG. 6 illustrates a perspective view of the exemplary embodiment of the cleaning assembly of FIG. 3 in which is placed the device to be cleaned internally through ports located on five sides of the device; and

FIG. 7 is a flow chart of an exemplary embodiment of the method for cleaning internal pathways of a valve.

### DETAILED DESCRIPTION

While the present disclosure may be embodied in various forms, there will hereinafter be described some exemplary and non-limiting embodiments, with the understanding that the present disclosure is to be considered an exemplification of the disclosure and is not intended to limit the disclosure to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

As stated above, businesses would like to rebuild used air valve bodies. During the rebuilding process, a valve body is disassembled, pressure cleaned with fluids, and an individual manually rotates the valve body repeatedly to blow dry all ports with an air gun. Accordingly, conventionally an individual is needed for internal cleaning of devices and blow drying their ports. Moreover, a problem especially common to air valve bodies or any device with internal activities is that over time during operation their interior pathways develop undesired debris (residues).

In view of the above-noted problems, a preferred exemplary embodiment of an apparatus configured for internally cleaning devices through their ports using an assembly equipped with nozzles is provided. Moreover, the provided apparatus is configured to internally clean devices through their ports in a speedy and efficient manner.

Reference now is made in detail to the embodiments illustrated in the accompanying drawings and discussed below.

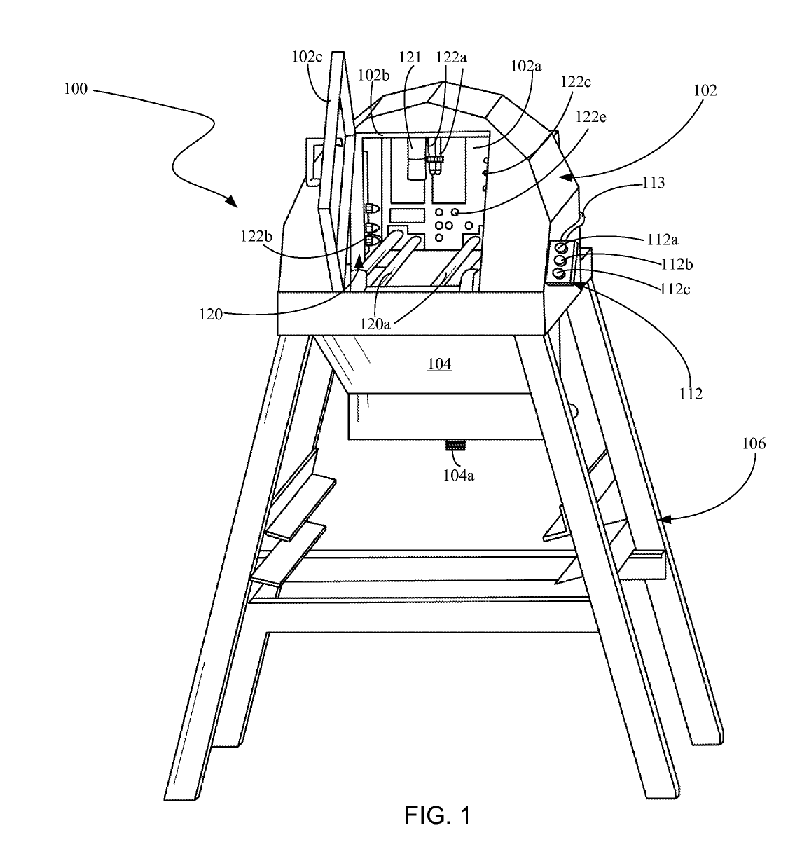

FIG. 1 illustrates a front side elevation view of an exemplary embodiment of an apparatus for cleaning castings through their ports. As shown, an apparatus 100 for cleaning internal pathways of devices through their ports includes an upper housing 102 and a lower housing 104, which are affixed to a support frame 106.

As shown, the upper housing 102, which is positioned above a top level of the support frame 104, includes a cleaning chamber 102a defined therein as a space for accommodating and cleaning devices, such as valves, having ports formed on external sides as openings of the internal pathways. The cleaning chamber 102a is provided with a gateway 102b on a front side thereof and in which is positioned a cleaning assembly 120. The upper housing 102 further includes an opening unit (i.e., door) 102c for openably closing the gateway 102b, and a push-button control box 112 for starting, stopping, and providing a status of a cleaning process of a device placed inside the cleaning assembly 120. As shown, the push-button control box 112 includes a start button 112a, a stop button 112b, and a cleaning status light indicator 112c. In one exemplary embodiment, the status light indicator 112c is configured to inform an operator of the apparatus 100 of a current cleaning status of a device or faults using a flashing frequency.

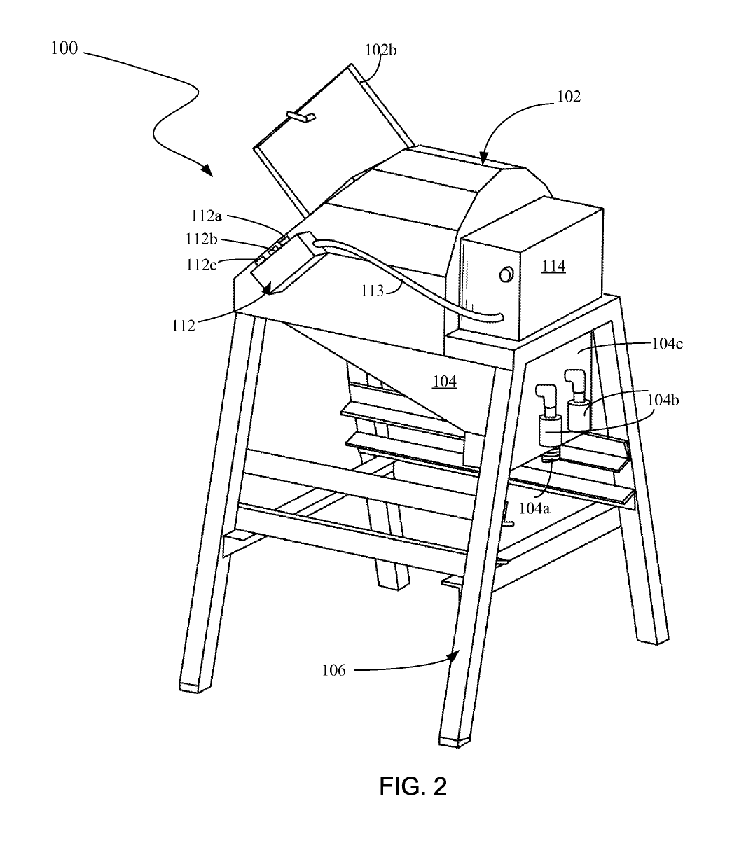

As shown, the lower housing 104, which is positioned below the top level of the support frame 106, is configured to collect in an internal chamber spent cleaning media (e.g. cleaning liquids) and cleaning airs during corresponding cleaning processes. Moreover, as shown in FIG. 2, the lower housing 104 includes a drain 104a located at a low base of the internal chamber to drop off the spent cleaning liquids, and a couple of air exhaust units 104b positioned on a back side 104c to enable the exhaust of spent cleaning airs.

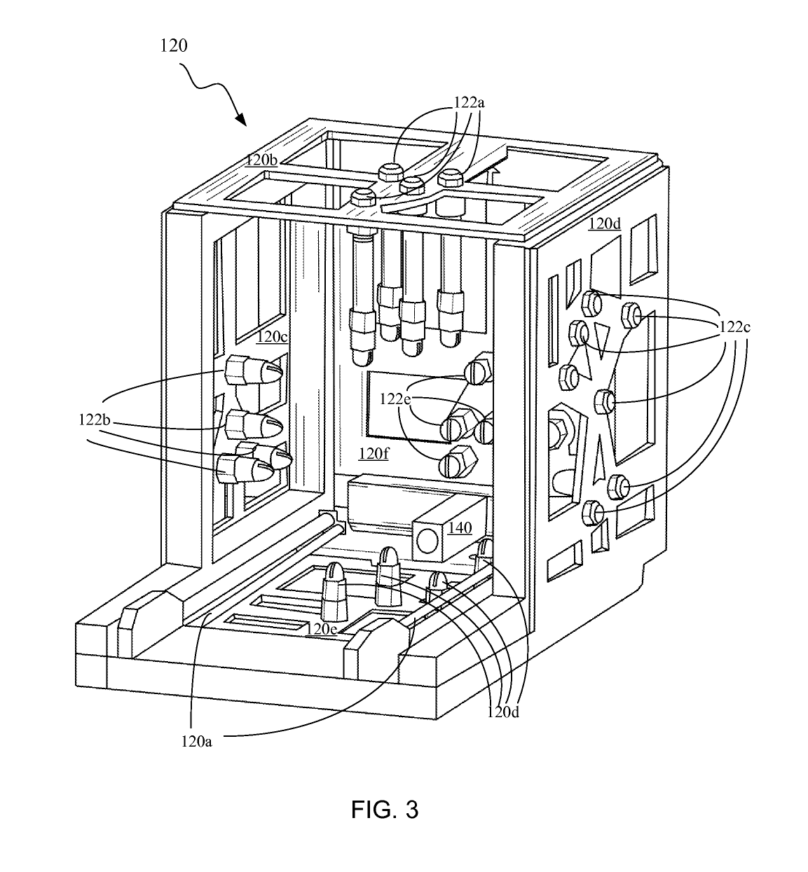

Still referring to FIG. 1, as shown, the cleaning assembly 120 includes a pair of guide rails 120a on which a device to be cleaned is placed by the operator, and a plurality of nozzles 121, and 122a-122e, as also shown in FIG. 3, used for spraying pressurized cleaning solutions (media) toward the ports of the placed device.

FIG. 2 illustrates a perspective elevation view of the exemplary embodiment of the apparatus for cleaning devices through their ports of FIG. 1. As shown in FIG. 2, the cleaning apparatus 100 includes a cleaning control unit 114 positioned behind a back side 102c of the upper housing 102. The cleaning control unit 114 is coupled via an electrical or digital communication cable 113 to the push-button control box 112, and includes a programmable logic controller (PLC) that is configured to control the cleaning process of devices placed within the cleaning assembly 120. Moreover, the cleaning control unit 114 includes a control board, a plurality of operation buttons, and a monitor.

In accordance with an exemplary embodiment of the present disclosure, the cleaning control unit 114 is programmable to provide a plurality of blowing sequences of predetermined time periods (lengths) from the nozzles to a predetermined set of ports of a device, such as a valve to be cleaned internally. As such, during a cleaning process of a particular valve, the cleaning control unit 114 is configured to activate the full set of cleaning nozzles simultaneously. Alternatively, during a cleaning process of a particular valve, the cleaning control unit 114 is configured to provide a variable sequence of cleaning nozzles which allows a cleaning nozzle staging by only allowing one set (i.e., bank) of nozzles to be active at a time. This alternate variable sequence is useful in providing the debris trapped in the internal pathways of the valve a pre-defined flow path in all available directions, sequentially.

Moreover, as described hereafter for the method for internally cleaning devices through their ports, the cleaning control unit 114 is programmable for an adjustable cycle time, a cleaning duration, and a nozzle order.

FIG. 3 illustrates a perspective view of an exemplary embodiment of the cleaning assembly 120 to which a plurality of nozzles is affixed for the cleaning process of a particular device through its opening ports. As shown in FIG. 3, the cleaning assembly 120 includes a frame 121 and a set of five side covering members 120b-120f, which are affixed to only five sides of the frame 121. As shown, a front side of the frame 121 is not covered so as to enable the moving of the device to be cleaned in and out of the cleaning assembly 120.

Still referring to FIG. 3, to each one of the five side covers 120b-120f a predetermined set of nozzles 122a-122e is affixed thereon, respectively. As show in FIG. 3, this cleaning assembly 120 includes four nozzles 122a affixed to the top side cover 120b, four nozzles 122b affixed to the left side cover 120c, seven nozzles 122c affixed to the right side cover 120d, four nozzles 122d affixed to the bottom side cover 120e, and four nozzles 122e affixed to the back side cover 120f.

In accordance to an exemplary embodiment of the present disclosure, the five sets of nozzles 122a-122e are affixed to the cleaning assembly 120 to appropriately match the number and positions of ports formed on corresponding sides of the device to be cleaned.

In accordance to another exemplary embodiment of the present disclosure, the five sets of nozzles 122a-122e are affixed to the cleaning assembly 120 for the cleaning of a predetermined number of different devices, more than one. As such, the number of nozzles affixed to each one of the side covers 120b-120f matches the total number of the differently positioned ports of the corresponding sides of the predetermined number of different devices. For example when arranged for the cleaning of two different devices, the cleaning assembly 120 includes seven (7) nozzles on one of the side covers when the first device includes four ports on a corresponding side, the second device includes six ports on a corresponding side, and only three of the four ports of the first device have positions that are similar to the positions of three of the six ports of the second device.

As shown in FIG. 3, the bottom side cover 120e includes an at least partially opened portion 123 to enable spent cleaning liquids to drop down to the drain chamber of the lower housing 104.

In addition to the pair of guide rails 120a on which a device to be cleaned is placed by the operator, the cleaning assembly 120 includes a movable member 140 that extends internally from the back side, and which is coupled to and enables the cleaning control unit 114 to determine a positive cleaning position of the valve whose back side is in contact with a front end of the movable member 140 when placed on the guide rails 120a.

In accordance with an exemplary embodiment of the present disclosure, the movable member 140 can be moved forward and backward along a longitudinal axis of the guide rails 120a by an operator so that a front end of the movable member 140 can be positioned at a predetermined number of positions from the back side of the cleaning assembly, each of which corresponds to a specific positive cleaning position of a particular valve, or of a different version of the particular valve, thereby preventing even minor deviations from the positive cleaning positions which would block a few ports of the particular valve from being properly aligned to activated nozzles of the cleaning assembly 120.

Moreover, in accordance with another exemplary embodiment of the present disclosure, as the valve to be cleaned inside the cleaning assembly 120 can be positioned on multiple positions on the guide rails 120a. This alternate positioning enables proper pathways linking ports to nozzles to be realigned on four sides simultaneously. In addition, the fifth side, or back side of the valve, need not be adjusted because each valve version valve has different ports. This is solved by dedicating individual cleaning nozzles affixed to the back side cover 120f of the cleaning assembly 120 for specific valve versions.

As discussed hereafter during the description of the cleaning process, prior to placing the device inside the cleaning assembly 120 the operator adjusts a position of the movable member 140 to ensure that the valve to be cleaned is placed in the positive cleaning position once in contact with the movable member 140.

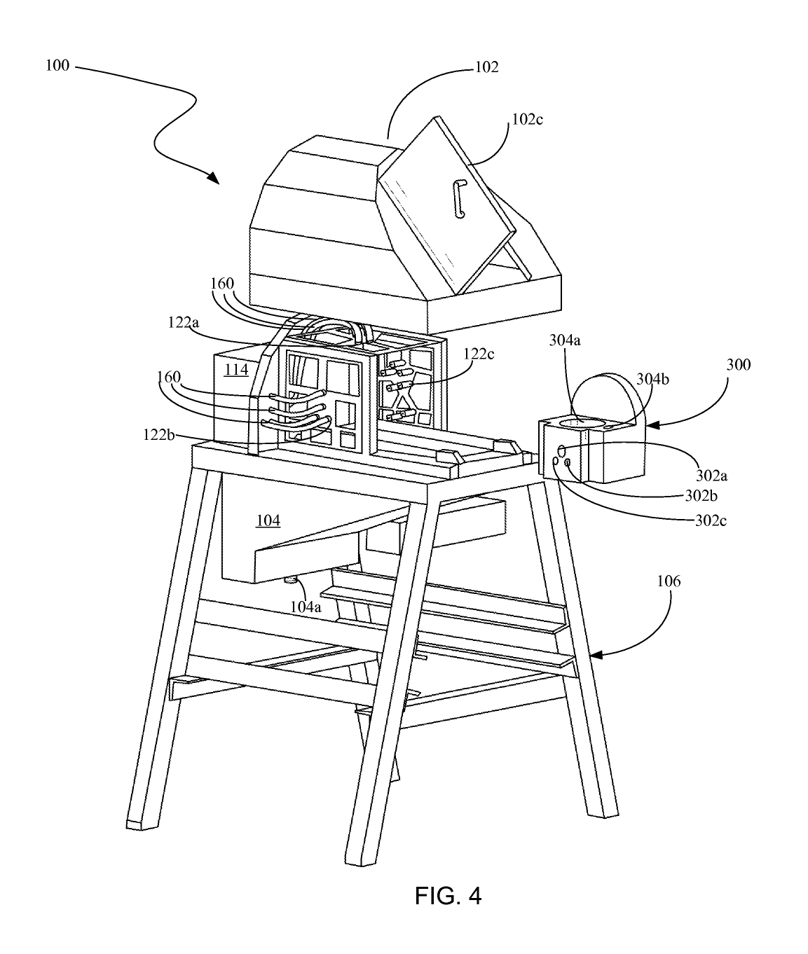

FIG. 4 illustrates an exploded perspective view of the upper housing 102 of the exemplary embodiment of the apparatus 100 and a perspective view of a valve to be placed inside the cleaning assembly 120 for cleaning the internal pathways of the valve. As shown, a valve 300 to be cleaned inside the cleaning assembly 120 includes on a left side 302 three ports 302a-302c, and on a top side 304 a large port 304a and a small port 304b. As shown again, the left side cover 120c of the cleaning assembly 120 includes four nozzles 122b, three of which are positioned to be suitably aligned towards the three ports 302a-302c during any cleaning sequence of the internal pathways of the valve 300. As such, the fourth and top nozzle of the four nozzles 122b will never be activated during any cleaning sequence of the internal pathways of the valve 300.

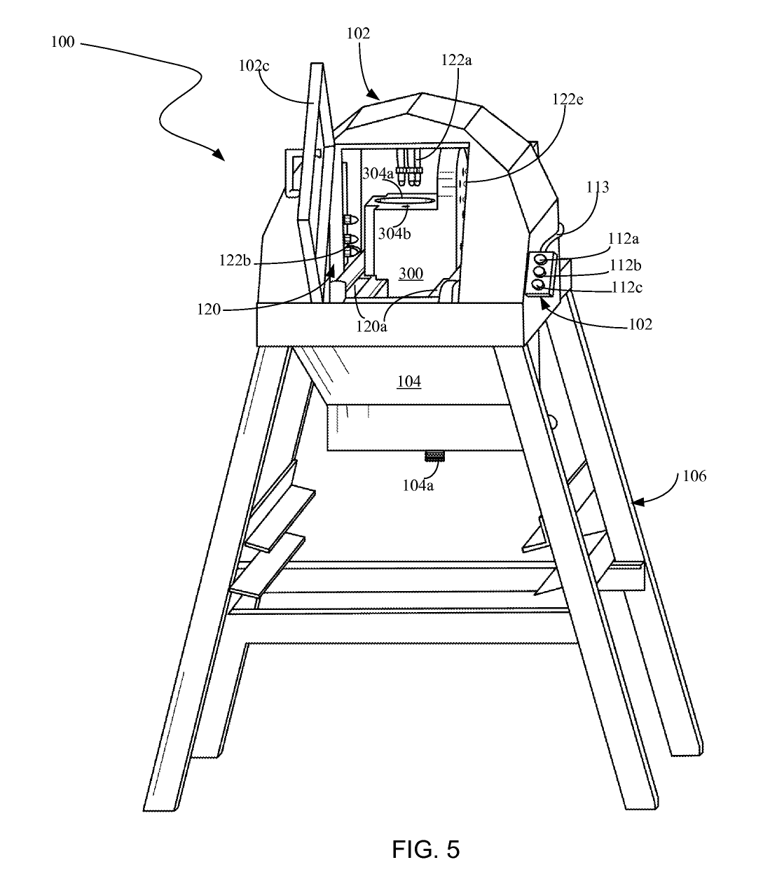

Moreover as shown in FIGS. 4, 5, and 6, the top side cover 120b of the cleaning assembly 120 includes four nozzles 122a, three of which are suitably aligned towards the large port 304a and the front fourth nozzle is suitably aligned towards the small port 304b. In addition as shown, the right side cover 120d includes seven nozzles 122c all of which are suitably aligned towards seven ports 306 that are formed on a right side 306 of the valve 300.

Although not shown, the valve 300 also includes four ports that are formed on a back side 308, and three ports and a drain formed on a bottom side 310. The drain is useful as it is an exit point of spent cleaning solutions and debris removed from the ports and pathways of the valve 300. Moreover during the cleaning process of the valve 300, though one the four nozzles 122d affixed to the bottom side cover 120e is suitably aligned towards the drain of the valve 300, the cleaning control unit 114 is configurable not to provide any pressurized cleaning liquids or air through that one of the four nozzles to prevent any blockage of the drainage of spent cleaning solutions and debris through the drain.

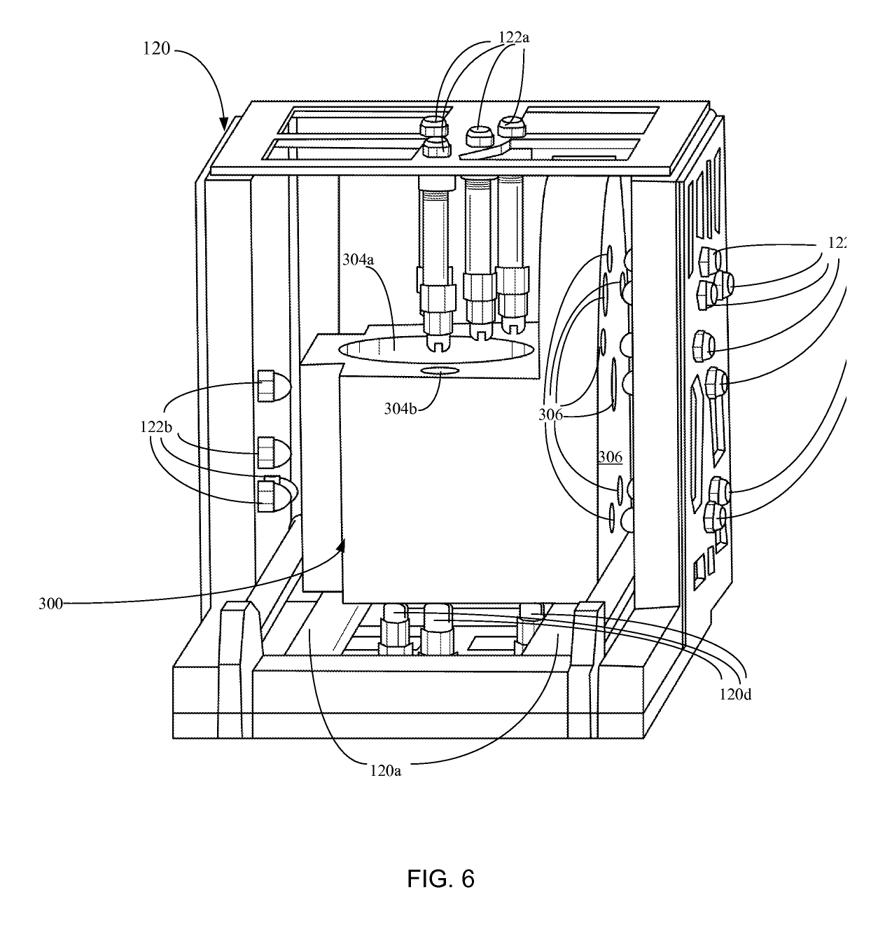

Moreover as shown in FIG. 6, when the cleaning assembly 120 positioned inside the upper housing 102 each nozzle of the set of nozzles 122a, 122b, 122c, 122d, and 122e is connected to a liquid and air conduit 160, hereafter referred to as a flexible line tubing, which enables a coupling to a source of cleaning liquids and air, such as a high pressure pump, which is associated with the cleaning control unit 114.

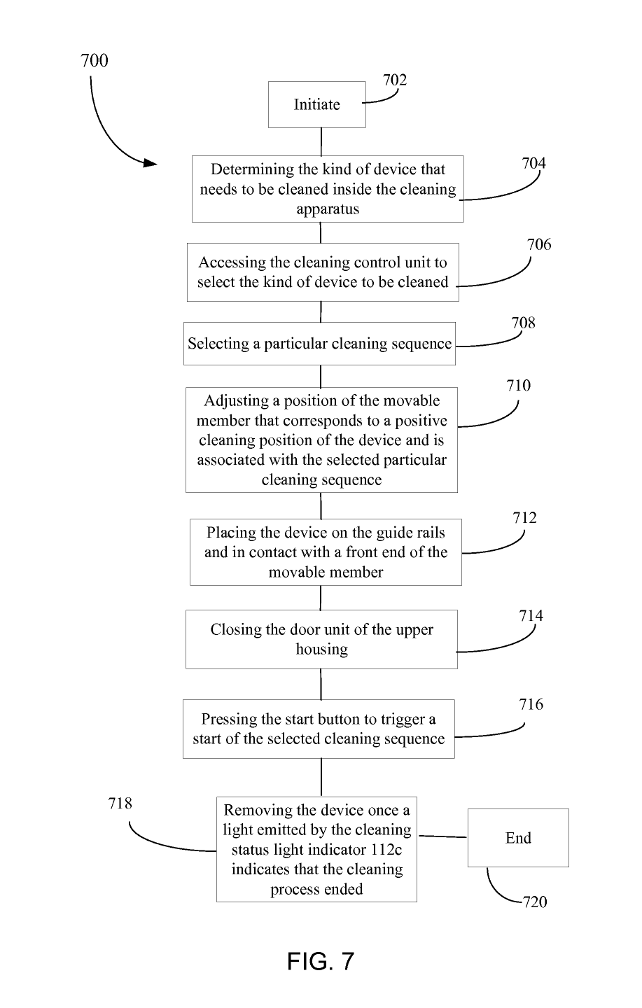

Now referring to FIG. 7, which is a flow chart 700 of an exemplary embodiment of the method for cleaning internal pathways of a valve initiated at Step 702. The user or operator, who would like to have the internal pathways of the device 300 cleaned by the cleaning apparatus 100 by placing it inside the cleaning assembly 120, should determine what kind and/or version is the device 300 prior to accessing the cleaning control unit 114, at Step 704. At Step 706, once the kind and/or version of the device 300 is determined, the operator accesses the cleaning control unit 114 to enter via a user interface or select from a displayed list of devices the determined kind and/or version of the device 300, at Step 708.

At Step 710, the operator proceeds with the adjustment of a position of the movable member 140 that corresponds to a positive cleaning position of the device 300 on the guide rails 120a and is associated with the selected particular cleaning sequence. After adjusting the position of the movable member 140, the operator proceeds to place the device 300 on the guide rails 120a and in contact with a front end 140a of the movable member 140, at Step 712.

Subsequently, at Step 714, the operator proceeds with the closing of the door 102c of the upper housing, and pressing the start button 112a to trigger the start of the selected cleaning sequence by the cleaning control unit 114, at Step 716.

In accordance with an exemplary embodiment of the present disclosure, the cleaning apparatus 100 includes proximity switches that are configured to determine whether the door 102c is closed (latched) and whether the device 300 is placed on the guide rails 120a. Upon determination that the door 102c is latched and that the device 300 is rightly placed, and detection of the pressing of the start button 112a, the cleaning control unit 114 starts the cleaning sequence that was selected by the operator.

At step 718, once a light emitted by the cleaning status light indicator 112c indicates that the cleaning sequence has ended, the operator can reopen the door 102c to remove the device 300 out of the cleaning apparatus 100.

In accordance with an exemplary embodiment of the present disclosure, a cycle time of each one of the selectable cleaning sequences lasts a predetermined time period, such as four minutes for example. As such, in addition to being efficient in the cleaning process of internal pathways of devices, the cleaning apparatus handles each of the selectable cleaning sequences in speedy manners.

While certain embodiments of the present disclosure have been described, it will be appreciated that changes and modifications can be made and that other embodiments may be devised without departing from the true spirit and scope of the present disclosure.

1. An apparatus for cleaning internally a device having internal pathways and five sets of pathway ports, each of which is positioned one of five sides of the device, comprising:
an upper housing that includes a cleaning chamber defined therein and a getaway that is openably closed by a door unit;
a cleaning assembly, which is installed within the cleaning chamber, includes five sets of nozzles, each of which is positioned on one of five sides of the cleaning assembly, and a couple of guide rails on which the device is placed during a cleaning process;
a cleaning control unit configured to control the cleaning process of the device once placed within the cleaning assembly, wherein the cleaning control unit is coupled to a pressure pump that is coupled to the five sets of nozzles to provide cleaning media at a predetermined pressure to the five sets of pathway ports during the cleaning process; and
a push-button control unit is configured for starting, stopping, and providing a status of the cleaning process, and is coupled to the cleaning control unit.

2. The apparatus of claim 1, wherein the cleaning assembly further includes internally a movable member that extends from a back end along a longitudinal axis of the guide rails so that a front end of the movable member can be positioned by an operator at a predetermined number of positions from the back side of the cleaning assembly, each of which corresponds to a specific positive cleaning position of the device.

3. The apparatus of claim 2, the push-button control unit includes a start button, a stop button, and a cleaning status light indicator, which is configured to inform the operator about a current cleaning status of the device.

4. The apparatus of claim 3, wherein the cleaning status light indicator is further configured to inform the operator about faults of the cleaning process using a flashing frequency.
